(19) United States
(12) Patent Application Publication
(10) Pub. No.: US 2003/0029326 A1
(43) Pub. Date: Feb. 13, 2003

(54) Egg cracker

(76) Inventor: Culver Dean Whitcomb, Crosslake, MN (US)

Correspondence Address: Culver d. Whitcomb, 34001 Sunrise Is., Crosslake, MN, 56442, US

(21) Appl. No.: 10/166,542

(22) Filed: Jun. 11, 2002

Related U.S. Application Data
(60) Provisional application No. 60/311,224, filed on Aug. 10, 2001.

(51) Int. Cl. A47J 37/08

(52) U.S. Cl. 99/394; 99/421 A

(57) ABSTRACT

The egg cracker is a kitchen utensil that can be held in one hand and by using a finger to move a lever can crack open an egg shell so the contents of the egg shell can be separated from the shell and the shell can be disposed of by pressing a lever and turning the utensil so the top side is facing down.

A provisional Patent Application NO. 60/311,224 has been filed and confirmation NO. 4470 has been received. The filing date is Aug. 10, 2001. This application was for the egg cracker. The inventor is Culver Dean Whitcomb, a citizen of the United States, and resides at 34001 Sunrise Island, Crosslake, Minn. 56442.

### STATEMENT REGARDING FEDERALLY SPONSORED RESEARCH OR DEVELOPMENT

“Not Applicable”

### REFERENCE TO SEQUENCE LISTING, A TABLE OR A COMPUTER PROGRAM LISTING COMPACT DISC APPENDIX

“Not Applicable”

### BACKGROUND OF INVENTION

For hundreds of years, the cook in the family has cracked the eggs for breakfast, got egg on their fingers and have had to wash and wipe their hands. This is not only an inconvenience, but it removes oil from your hands and it takes time that could be used to get breakfast on the table a little faster.

The egg cracker is a kitchen utensil, that with one hand can crack an egg, deposit the yoke into a pan and the shell can be put into the garbage. The tool is simple in design and can be made of plastic or metal with minor metal parts.

### DESCRIPTION OF THE SEVERAL VIEWS OF THE DRAWING

FIG 1. End view of the egg cracker looking at the end of the handle.

FIG 2. Plan view, or top view, looking down at the egg cracker.

FIG 3. Side view of the egg cracker as it would appear on a countertop.

FIG 4. End view of barb 17.

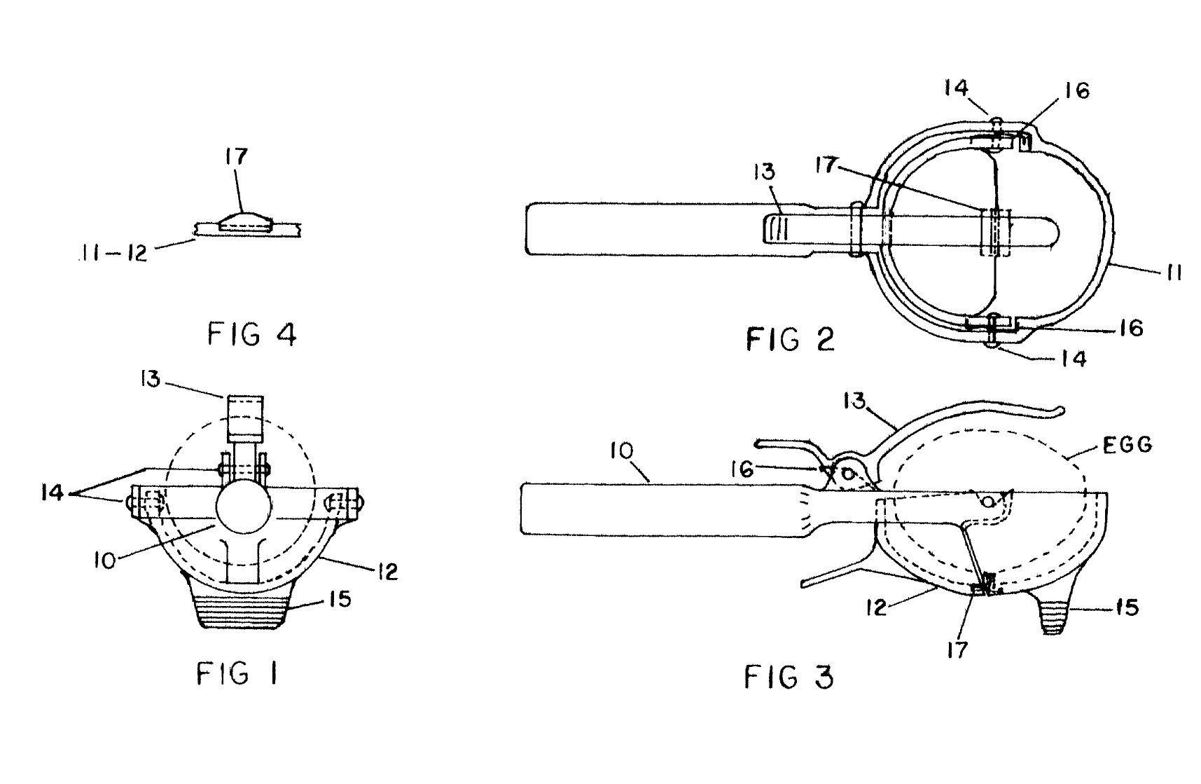

### LIST OF REFERENCE NUMERALS UTILIZED IN THE DRAWING

10 Handle

11 Stationary Pad

12 Movable Pad

13 Hold down lever

14 Rivet or pin

15 Bumper

16 Spring

17 Metal barb (2)

### DESCRIPTION OF THE INVENTION

The egg cracker is a kitchen utensil designed to crack an egg and, with the movement of a lever, deposit the egg yoke and whites into a container. This utensil can be manufactured of metal or plastic and the four main parts, 10, 11, 12, 13, assembled to form the egg cracker.

Three hold down springs 16 hold their respective parts in place. 15 is a rubber or neoprene bumper which holds the egg cracker in an upright position when set on a flat level surface.

10 is the handle and I 1 Is a stationary pod of the egg cracker. 12 is the movable pod of the egg cracker, which is moved by an attached lever. 13 is the hold lever of the egg cracker, which shall hold the egg in the pod so it does not fall out. 17, these are the barbs which are anchored in the stationary pod and in the movable pod. 14, these are rivets or pins which hold the separate parts together and are pivet shafts for 12 and 13.

To use the egg cracker, place the utensil on the counter or hold it in your hand. Press down on hold down lever 13, place an egg into the utensil. Tap the utensil on the counter on the rubber bumper end 15, gently. This causes the egg to drop down over the (2) barbs, penetrating the egg shell. Place the utensil over a container and with your trigger finger pull the lever on the movable pod 12. This cracks the egg shell and the yoke and whites of the egg fall into the container. Release lever on movable pod 12 and press hold down lever 13 and turn the utensil over to empty the egg shell into the garbage.

1. What I claim as my invention is that this kitchen utensil, with one hand can crack open an egg and the holder can deposit the yoke and whites into a pan and dispose of the egg shell without the contents of the egg shell touching the users hand. A convenience for the user, essential for the handicapped.

2. This kitchen utensil has (2) two moving parts and can be held in one hand, and by the use of a finger to move a lever, can crack open an egg and dispose of the egg shell.
